(19) United States
(12) Patent Application Publication
(10) Pub. No.: US 2026/0281941 A1
(43) Pub. Date: Sep. 17, 2026

(54) METHOD AND APPARATUS FOR EXTENDED LOCAL AREA DATA NETWORK INFORMATION MANAGEMENT IN MOBILE COMMUNICATIONS

(71) Applicant: MEDIATEK INC., Hsinchu City (TW)

(72) Inventors: Yu-Hsin LIN, Hsinchu City (TW); Chi-Hsien CHEN, Hsinchu City (TW)

(21) Appl. No.: 19/472,694

(22) PCT Filed: Aug. 30, 2024
(86) PCT No.: PCT/CN2024/115839

§ 371 Date: Oct. 5, 2025

Related U.S. Application Data
(60) Provisional application No. 63/587,172, filed on Oct. 2, 2023.

(51) Int. Cl. H04W 60/06; H04W 48/16; H04W 88/06

(52) U.S. Cl. CPC H04W 60/06; H04W 48/16; H04W 88/06

(57) ABSTRACT

Various solutions for extended local area data network (LADN) information management with respect to user equipment in mobile communications are described. An apparatus may receive a message including an extended LADN information from a network node. The extended LADN information may be associated with at least one network slicing information. The apparatus may store the extended LADN information carried by the received message. The apparatus may delete the extended LADN information in an event that the apparatus moves to a deregistered state.

### CROSS REFERENCE TO RELATED PATENT APPLICATION(S)

The present disclosure is part of a non-provisional application claiming the priority benefit of U.S. Patent Application No. 63/587,172, filed 2 Oct. 2023, the content of which herein being incorporated by reference in its entirety.

### TECHNICAL FIELD

The present disclosure is generally related to mobile communications and, more particularly, to extended local area data network (LADN) information management with respect to user equipment in mobile communications.

### BACKGROUND

Unless otherwise indicated herein, approaches described in this section are not prior art to the claims listed below and are not admitted as prior art by inclusion in this section.

Fifth generation (5G) network architecture developed by the 3rd Generation Partnership Project (3GPP) supports network slicing. For example, the physical network infrastructure can be partitioned into multiple slices of virtual networks. Different network slices can have different supported features and network function optimizations, and thus can be adapted to different use cases. Network slicing information contains information about which network slices a user equipment (UE) can establish protocol data unit (PDU) sessions on after completing registration. However, if the UE has previously entered a deregistered state, this information could be misused at the next registration, so there is a need for an effective method to management such information.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to extended local area data network (LADN) information management with respect to user equipment (UE) in mobile communications.

In one aspect, a method may involve an apparatus receiving a message including an extended LADN information from a network node. The extended LADN information may be associated with at least one network slicing information. The method may also involve the apparatus storing the extended LADN information. The method may further involve the apparatus deleting the extended LADN information in an event that the apparatus moves to a deregistered state.

In one aspect, an apparatus may comprise a transceiver which, during operation, wirelessly communicates with a network node. The apparatus may also comprise a processor communicatively coupled to the transceiver. The processor, during operation, may perform operations comprising receiving a message including an extended local area data network (LADN) information from the network node. The extended LADN information may be associated with at least one network slicing information. The processor may also perform operations comprising storing the extended LADN information. The processor may further perform operations comprising deleting the extended LADN information in an event that the apparatus moves to a deregistered state.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B 5 G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of extended local area data network (LADN) information management in accordance with implementations of the present disclosure.

FIG. 2 is a diagram depicting another example scenario of extended LADN information management in accordance with implementations of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to extended local area data network (LADN) information management in mobile communications, so as to ensure that the extended LADN information can be used correctly by the user equipment (UE). According to the present disclosure, a number of possible solutions may be implemented separately or jointly. That is, although these possible solutions may be described below separately, two or more of these possible solutions may be implemented in one combination or another.

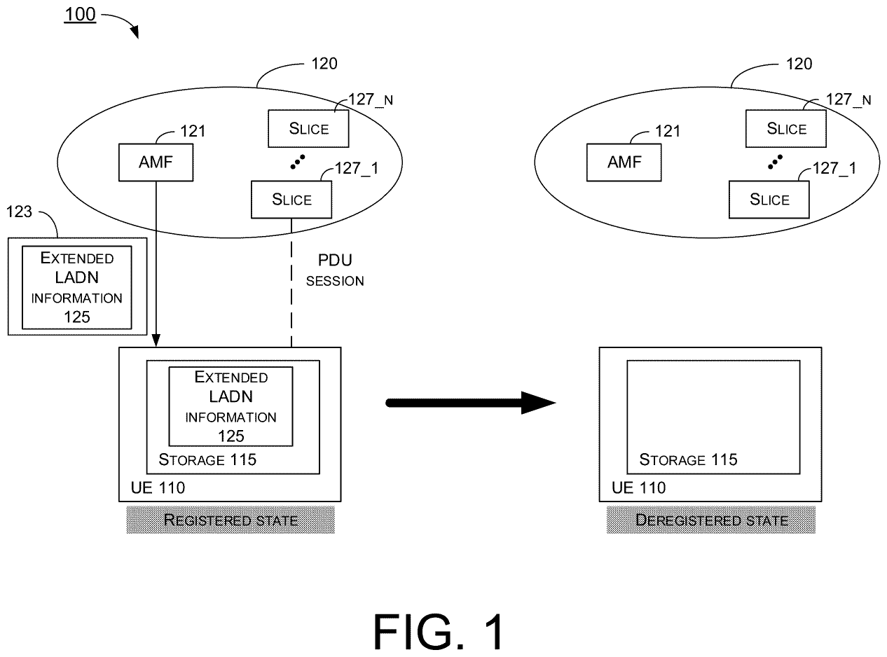

FIG. 1 illustrates an example scenario 100 of extended LADN information management in which various solutions and schemes in accordance with the present disclosure may be implemented. In scenario 100, the UE 110 may perform a registration procedure when it enters the network 120. The network 120 may be a public land mobile network (PLMN) and support network slicing. In this embodiment, the resources in the network 120 may be partitioned into N network slices (e.g., slices 127_1 to 127_N). Different network slices may have different supported features and network function optimizations, and thus can be used for different applications at the UE 110. In the registration procedure, the UE 110 may send a registration request message to an access and mobility management function (AMF) 121 in the network 120. The AMF 121 may send a registration accept message (e.g., the message 123) back to the UE 110. The registration accept message may include the extended LADN information 125 associated with at least one network slicing information. For example, the network slicing information may be a single network slicing selection assistance information (S-NSSAI). In scenario 100, the extended LADN information 125 included in the registration accept message may be associated with one or more S-NSSAIs, which indicates slice(s) in the network 120 that the UE 110 can use for a specific area. To be specific, the extended LADN information 125 may include different LADNs each including a data network name (DNN), an S-NSSAI and a 5G system (5GS) tracking area identity list. Alternatively, the UE may get the information whether a DNN is a LADN DNN from LADN Information during the registration procedure. The UE may receive the LADN Information per LADN DNN and S-NSSAI. The UE 110 stores the extended LADN information 125 carried by the received message 123 into the storage 115. After that, the UE 110 may establish a protocol data unit (PDU) session according to the extended LADN information 125. For example, the UE 110 selects a S-NSSAI within the extended LADN information 125, which indicates the slice 127_1 to which the UE 110 intends to establish the PDU session. Then, the UE 110 includes the selected S-NSSAI in the PDU session establishment request message. So that the PDU session with the DNN and S-NSSAI associated with the corresponding LADN can be established accordingly.

In some cases, the AMF may initiate a configuration update procedure and send a configuration update command message (may also be represented by the message 123) to the UE 110. The configuration update command message may include the extended LADN information 125 associated with at least one network slicing information (e.g., one or a set of S-NSSAIs). The UE 110 may store the extended LADN information 125 carried by the configuration update command message into the storage 115.

In an event that the UE 110 moves to a deregistered state from the registered state, the UE 110 deletes the extended LADN information 125 previously stored in the storage 115. For example, the deregistered state may be a 5G mobility management (5GMM) deregistered state. And in another example, the UE 110 moves to the deregistered state as a result of a de-registration procedure. As the extended LADN information 125 has been deleted from the storage 115, the situation of misusing the improper extended LADN information by the UE 110 at the next registration can be avoided.

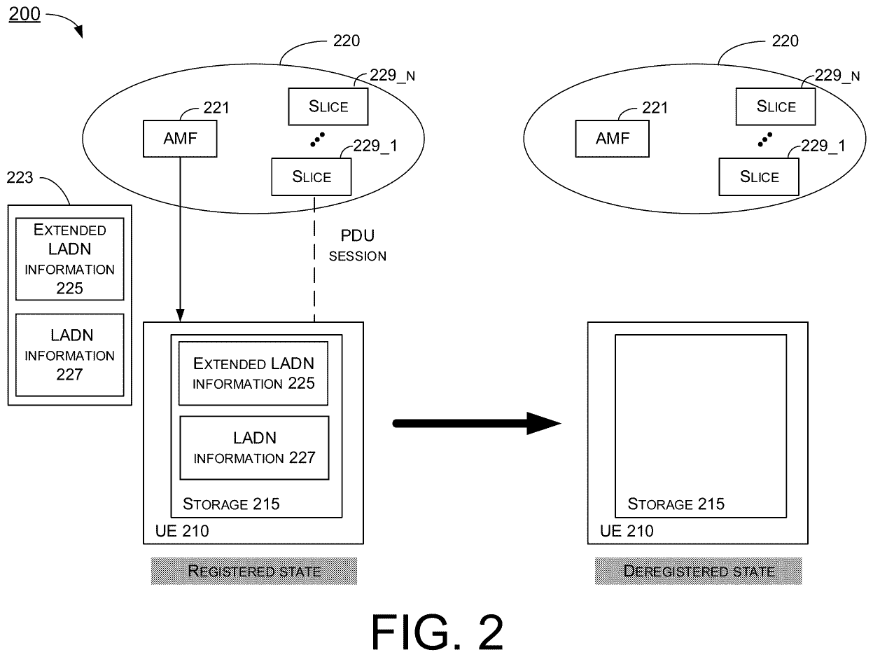

FIG. 2 illustrates another example scenario 200 of extended LADN information management in which various solutions and schemes in accordance with the present disclosure may be implemented. In scenario 200, not only the extended LADN information 225 but also an LADN information 227 are carried by the message 223 sent to the UE 210 by the AMF 221 in the network 220 (which may be a PLMN). In this embodiment, the extended LADN information 225 is associated with at least one network slicing information, whereas the LADN information 227 is not associated with any network slicing information. The UE may support LADN per DNN and S-NSSAI. The message 223 may be a registration accept message or a configuration update command message, and the extended LADN information 225 and the LADN information 227 correspond to different information element identifiers (IEIs) of the message 223. For example, in an event that the message 223 is the registration accept message, the extended LADN information 225 included in the message 223 corresponds to an IEI of 7D, and the LADN information 227 included in the message 223 corresponds to an IEI of 79.

In an event that the message 223 is the configuration update command message, the extended LADN information 225 included in the message 223 corresponds to an IEI of 78, and the LADN information 227 included in the message 223 corresponds to an IEI of 79. If the AMF needs to update the LADN information, the AMF shall include the LADN information in the LADN information IE of the CONFIGURATION UPDATE COMMAND message. If the UE supports LADN per DNN and S-NSSAI and the AMF needs to update the extended LADN information, the AMF shall include the extended LADN information in the Extended LADN information IE of the CONFIGURATION UPDATE COMMAND message.

After the UE 210 receives the message 223, the UE 210 stores the extended LADN information 225 and the LADN information 227 carried by the message 223 separately in the storage 215. When the UE 210 moves to the deregistered state such as 5GMM deregistered state, or the UE 210 moves to the deregistered state as a result of a de-registration procedure, the UE 210 deletes the extended LADN information 225 as well as the LADN information 227 previously stored in the storage 215. Therefore, misusing the extended LADN information and the LADN information at the next registration can be avoided.

### Illustrative Implementations

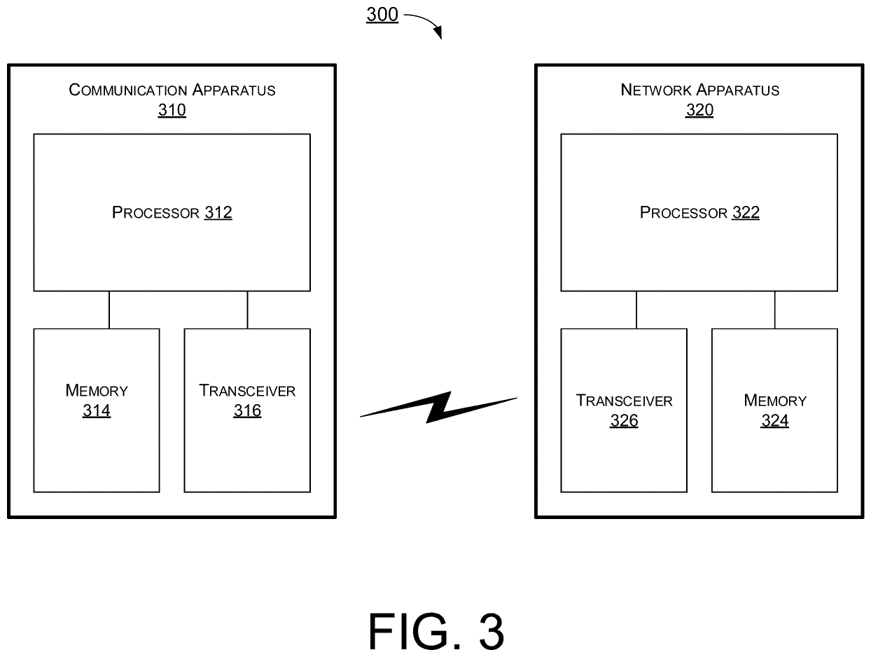

FIG. 3 illustrates an example communication system 300 having at least an example communication apparatus 310 and an example network apparatus 320 in accordance with an implementation of the present disclosure. Each of the communication apparatus 310 and network apparatus 320 may perform various functions to implement schemes, techniques, processes and methods described herein pertaining to extended LADN information management in mobile communications, including scenarios/schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Processor 322 may further include protocol stacks and a set of control functional modules and circuit. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of the processor 312 and processor 322 may be implemented in the form of one or more single-core processors, one or more multi-core processors, or one or more CISC processors. That is, even though a singular term “a processor” is used herein to refer to processor 312 and processor 322, each of the processor 312 and processor 322 may include multiple processors in some implementations and a single processor in other implementations in accordance with the present disclosure. In another aspect, each of the processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 312 and processor 322 is a special-purpose machine specifically designed, arranged and configured to perform specific tasks in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein.

In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

For illustrative purposes and without limitation, descriptions of capabilities of the communication apparatus 310 is provided below with process 400. In which, the communication apparatus 310 is implemented in or as a communication apparatus or a UE, and network apparatus 320 is implemented in or as a network node of a communication network.

### Illustrative Processes

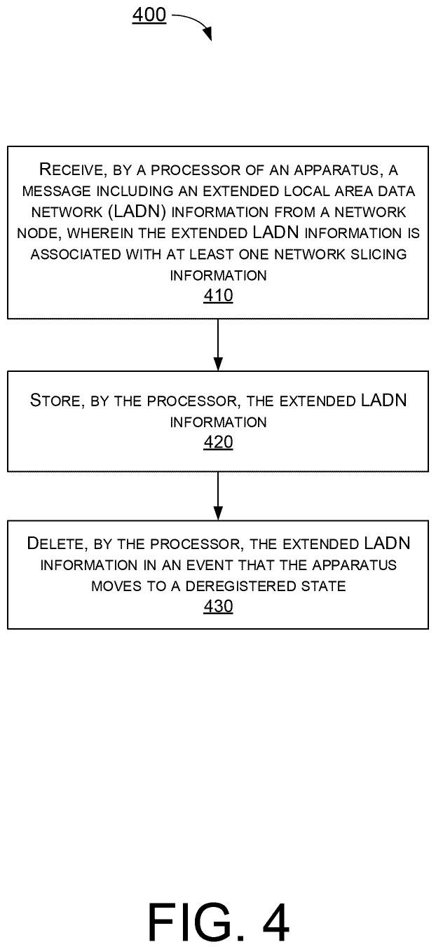

FIG. 4 illustrates an example process 400 in accordance with an implementation of the present disclosure. Process 400 may be an example implementation of above scenarios/schemes, whether partially or completely, with respect to extended LADN information management in mobile communications. Process 400 may represent an aspect of implementation of features of communication apparatus 310. Process 400 may include one or more operations, actions, or functions as illustrated by one or more of blocks 410, 420, and 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310 as a UE. Process 400 may begin at block 410.

At block 410, process 400 may involve processor 312 of communication apparatus 310 receiving a message including an extended LADN information from a network node. The extended LADN information may be associated with at least one network slicing information. Process 400 may proceed from block 410 to block 420.

At block 420, process 400 may involve processor 312 storing the extended LADN information. Process 400 may proceed from block 420 to block 430.

At block 430, process 400 may involve processor 312 deleting the extended LADN information in an event that communication apparatus 310 moves to a deregistered state.

In some implementations, the message may further include an LADN information. Process 400 may involve processor 312 storing the LADN information. Also, process 400 may involve processor 312 deleting the LADN information in an event that communication apparatus 310 moves to the deregistered state.

In some implementations, the LADN information is not associated with any network slicing information.

In some implementations, the extended LADN information and the LADN information correspond to different information element identifiers (IEIs) of the message.

In some implementations, process 400 may further involve processor 312 storing the extended LADN information and the LADN information separately.

In some implementations, the message may be a configuration update command message or a registration accept message.

In some implementations, the deregistered state may be a 5G mobility management (5GMM) deregistered state.

In some implementations, the network slicing information may be a single network slicing selection assistance information (S-NSSAI).

In some implementations, communication apparatus 310 moves to the deregistered as a result of a de-registration procedure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a message including an extended local area data network (LADN) information from a network node, wherein the extended LADN information is associated with at least one network slicing information;
storing, by the processor, the extended LADN information; and
deleting, by the processor, the extended LADN information in an event that the apparatus moves to a deregistered state.

2. The method of claim 1, wherein the message further includes an LADN information, and the method further comprises:
storing, by the processor, the LADN information; and
deleting, by the processor, the LADN information in an event that the apparatus moves to the deregistered state.

3. The method of claim 2, wherein the LADN information is not associated with any network slicing information.

4. The method of claim 2, wherein the extended LADN information and the LADN information correspond to different information element identifiers (IEIs) of the message.

5. The method of claim 2, further comprising:
storing, by the processor, the extended LADN information and the LADN information separately.

6. The method of claim 1, wherein the message comprises a configuration update command message or a registration accept message.

7. The method of claim 1, wherein the deregistered state comprises a 5G mobility management (5GMM) deregistered state.

8. The method of claim 1, wherein the at least one network slicing information comprises a single network slicing selection assistance information (S-NSSAI).

9. The method of claim 1, wherein the apparatus moves to the deregistered state as a result of a de-registration procedure.

10. An apparatus, comprising:
a transceiver which, during operation, communicates wirelessly; and
a processor communicatively coupled to the transceiver such that, during operation, the processor performs operations comprising:
receiving, via the transceiver, a message including an extended local area data network (LADN) information from a network node, wherein the extended LADN information is associated with at least one network slicing information;
storing the extended LADN information; and
deleting the extended LADN information in an event that the apparatus moves to a deregistered state.

11. The apparatus of claim 10, wherein the message further includes an LADN information, and during operation, the processor further performs operations comprising:
storing the LADN information; and
deleting the LADN information in an event that the apparatus moves to the deregistered state.

12. The apparatus of claim 11, wherein the LADN information is not associated with any network slicing information.

13. The apparatus of claim 11, wherein the extended LADN information and the LADN information correspond to different information element identifiers (IEIs) of the message.

14. The apparatus of claim 11, wherein, during operation, the processor further performs operations comprising:
storing the extended LADN information and the LADN information separately.

15. The apparatus of claim 10, wherein the message comprises a configuration update command message or a registration accept message.

16. The apparatus of claim 10, wherein the deregistered state comprises a 5G mobility management (5GMM) deregistered state.

17. The apparatus of claim 10, wherein the at least one network slicing information comprises a single network slicing selection assistance information (S-NSSAI).

18. The apparatus of claim 10. wherein the apparatus moves to the deregistered state as a result of a de-registration procedure.

17. The apparatus of claim 10, wherein the at least one network slicing information comprises a single network slicing selection assistance information (S-NSSAI).

18. The apparatus of claim 10. wherein the apparatus moves to the deregistered state as a result of a de-registration procedure.
